(19) United States
(12) Patent Application Publication
(10) Pub. No.: US 2016/0126747 A1
(43) Pub. Date: May 5, 2016

(54) NON-CONTACT POWER TRANSMISSION APPARATUS AND POWER TRANSMISSION DEVICE

(71) Applicant: TOSHIBA TEC KABUSHIKI KAISHA, Tokyo (JP)

(72) Inventors: Masakazu Kato, Numazu (JP); Masahiro Kanagawa, Mishima (JP)

(21) Appl. No.: 14/883,713

(22) Filed: Oct. 15, 2015

(30) Foreign Application Priority Data
Oct. 31, 2014 (JP) 2014-222936

(51) Int. Cl. H02J 5/00

(52) U.S. Cl. CPC H02J 5/005

(57) ABSTRACT

A non-contact power transmission apparatus comprises a power transmission device configured to include a power transmission circuit that is connected to a power transmission coil and supplies power and a current detection circuit that detects current supplied to the power transmission circuit; and a power receiving device configured to include a rectifier circuit which is connected to a power receiving coil, a voltage conversion circuit which is connected to the rectifier circuit and converts into voltage of driving a load circuit and a switching circuit which connects or disconnects the voltage generated by the voltage conversion circuit with the load circuit.

### CROSS-REFERENCE TO RELATED APPLICATION

This application is based upon and claims the benefit of priority from Japanese Patent Application No. 2014-222936, filed Oct. 31, 2014, the entire contents of which are incorporated herein by reference.

### FIELD

Embodiments described herein relate generally to a non-contact power transmission apparatus for transmitting power in a non-contact manner to a power receiving device from a power transmission device.

### BACKGROUND

In recent years, a non-contact power transmission apparatus for transmitting power in a non-contact manner is becoming popular. The non-contact power transmission apparatus, which is equipped with a power transmission device for supplying power and a power receiving device for receiving supplied power, uses electromagnetic coupling such as electromagnetic induction, magnetic field resonance and the like to transmit the power from the power transmission device to the power receiving device in a non-contact manner. The power receiving device is provided with a driving circuit for driving itself and a load circuit such as a charging circuit of secondary battery loaded in the power receiving device.

Japanese Unexamined Patent Application Publication No. 2011-229265 is known as a conventional technology of such a non-contact power transmission apparatus. In Patent Document 1, a non-contact power transmission apparatus is recorded which transmits power from the power transmission device to the power receiving device in a non-contact manner with the use of the electromagnetic coupling between the power transmission device and the power receiving device. A portable terminal serving as a power receiving device receives the power in a non-contact manner from a charger serving as a power transmission device and is charged by the secondary battery built in the portable terminal.

An authentication of whether or not the portable terminal mounted with the charger is a correct machine which should be mounted originally is carried out through communication using the electromagnetic coupling between the charger and the portable terminal mounted with the charger. When it is determined that the authentication is established, the portable terminal is assumed as a proper power transmission target and a continuous normal power transmission is started.

It is afraid that metal foreign objects are inserted between the charger serving as the power transmission device and the portable terminal serving as the power receiving device for some reasons. For example, while a coin is nipped between the power transmission device and the power receiving device by mistake, the charger is activated. In a conventional system of using the electromagnetic induction, as a frequency of about 100 kHz is often used, eddy current occurs in the metal foreign objects and heat is likely to be generated. Thus, in the technology recorded in Japanese Unexamined Patent Application Publication No. 2011-229265, it is possible to detect the metal foreign object during the period of normal power transmission, stop supplying power in a case in which the metal foreign object is detected and suppress the generation of heat of the metal foreign object.

A magnetic field resonance system capable of transmitting power is known as other non-contact power transmission system even if the power transmission device is separated from the power receiving device about a few cm. In the non-contact power transmission apparatus using the magnetic field resonance system, a frequency of a few MHz is often used for power transmission. For example, a frequency of 6.78 MHz or 13.56 MHz is used. In the magnetic field resonance system, it is unnecessary to closely contact the power transmission device with the power receiving device, as a gap exists between the power transmission device and the power receiving device, there is a possibility that foreign objects are nipped therebetween during the period of charging to the power receiving device in a non-contact manner for some reasons. In addition to the metal foreign objects such as coins and the like, for example, the foreign object also contains an IC card using 13.56 MHz. The IC card, thickness of which is about 1 mm and which includes an IC chip and an antenna wiring connected to the IC chip, operates while receiving the power from an IC card dedicated transmitter in a non-contact manner.

In a non-contact power transmission apparatus using frequencies 6.78 and 13.56, if the IC card which resonates with 13.56 MHz equal to double frequency of 6.78 MHz approaches to the power transmission device or is nipped between the power transmission device and the power receiving device, the IC card receives power and generates heat, and moreover the IC card can breakdown due to the generation of heat. Thus, it is important to detect the IC card, in addition to the metal foreign objects, which is called as foreign object detection.

The power consumed by the IC card is slight compared with the power transmitted to the power receiving device. For example, in a case in which the power received by the power receiving device of the non-contact power transmission apparatus is 20 W and the IC card receives 0.5 W power, even if the IC card is inserted between the power transmission device and the power receiving device, the received power only changes 0.5/20=0.025 (2.5%).

### BRIEF DESCRIPTION OF THE DRAWINGS

FIG. 1 is a block diagram illustrating the structure of a non-contact power transmission apparatus according to a first embodiment;

FIG. 2 is a perspective view illustrating the structure of the non-contact power transmission apparatus according to the first embodiment;

FIG. 3 is a flowchart illustrating the operation of the non-contact power transmission apparatus according to the first embodiment;

FIG. 4 is a timing diagram illustrating the operation of the non-contact power transmission apparatus according to the first embodiment;

FIG. 5 is a timing diagram illustrating the operation of the non-contact power transmission apparatus according to the first embodiment;

FIG. 6 is a flowchart illustrating the operation of a non-contact power transmission apparatus according to a second embodiment;

FIG. 7 is a timing diagram illustrating the operation of the non-contact power transmission apparatus according to the second embodiment;

FIG. 8 is a block diagram illustrating the structure of the non-contact power transmission apparatus according to the second embodiment;

FIG. 9 is a flowchart illustrating the operation of a non-contact power transmission apparatus according to a third embodiment; and

FIG. 10 is a timing diagram illustrating the operation of the non-contact power transmission apparatus according to the third embodiment.

### DETAILED DESCRIPTION

In accordance with an embodiment, a non-contact power transmission apparatus comprises a power transmission device which includes a power transmission coil, a power transmission circuit configured to be connected to the power transmission coil and supply power through the power transmission coil, a current detection circuit configured to detect current supplied to the power transmission circuit and a first control circuit configured to control the power transmission circuit; and a power receiving device which includes a power receiving coil, a rectifier circuit connected to the power receiving coil, voltage conversion circuit configured to be connected to the rectifier circuit and convert into voltage of driving a load circuit, a switching circuit configured to connect or disconnect the voltage generated by the voltage conversion circuit with the load circuit and a second control circuit configured to control the switching circuit.

The second control circuit, after starting to receive power, carries out a control processing to connect the load circuit during a period of time T0, then disconnect the load circuit during a period of time T1 and repeat connection and disconnection.

The first control circuit carries out a control processing to detect repeatedly current values at an interval of period of time T2 through the current detection circuit and stop power transmission if the current value is above a current threshold value during at least (T0+T1) time.

Hereinafter, the embodiment is described with reference to the accompanying drawings. Further, the same reference numerals indicate identical or similar structure in figures.

### First Embodiment

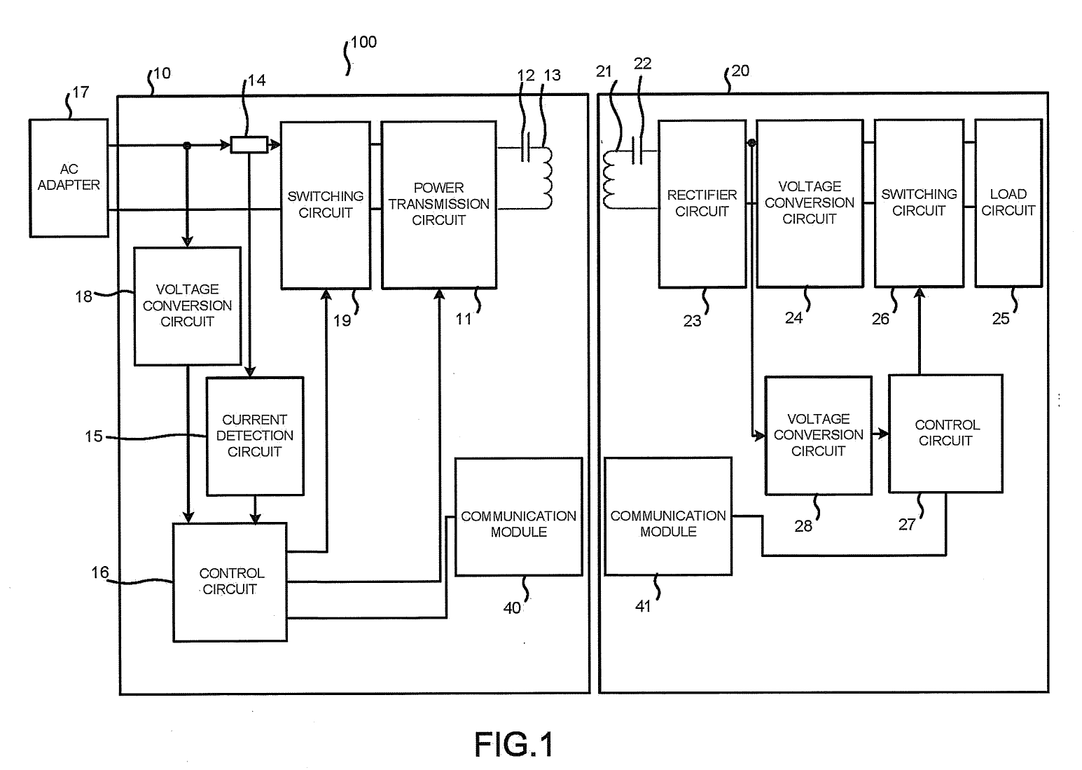

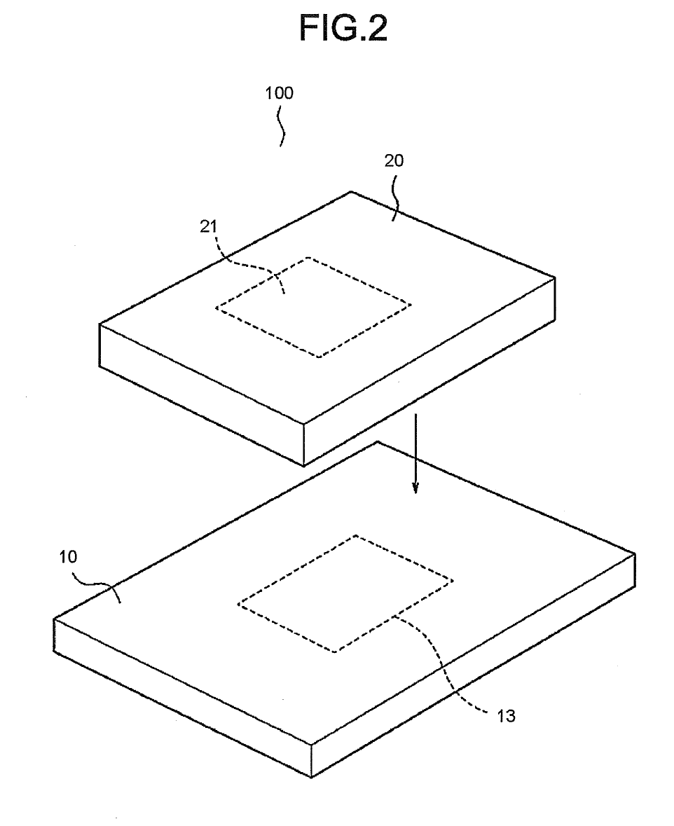

FIG. 1 is a block diagram illustrating the structure of a non-contact power transmission apparatus 100 according to a first embodiment. FIG. 2 is a perspective view schematically illustrating a power transmission device 10 and a power receiving device 20 which constitute the non-contact power transmission apparatus 100.

As shown in FIG. 1, the non-contact power transmission apparatus 100 is provided with the power transmission device 10 which supplies power and the power receiving device 20 which receives the supplied power. The power output from a power transmission circuit 11 is transmitted to the power receiving device 20 with the use of an electromagnetic coupling such as an electromagnetic induction or a magnetic field resonance between a power transmission coil 13 and a power receiving coil 21.

DC power is supplied to the power transmission device 10 from an external device via a power device such as AC adapter 17. The power transmission device 10 is provided with the power transmission circuit 11 for generating AC power, a resonance circuit constituted by a condenser 12 and the power transmission coil 13, a switching circuit 19 which supplies or stops supplying power to the power transmission circuit 11, a current sensor 14 for detecting DC current input to the power transmission circuit 11, a current detection circuit 15 for amplifying a tiny signal detected by the current sensor 14, a control circuit 16 and a voltage conversion circuit 18. The switching circuit 19 connects or disconnects the AC adapter 17 and the power transmission circuit 11 through a control signal from the control circuit 16 and switches the supply/stop of power from the power transmission device 10 to the power receiving device 20. The current sensor 14 is a small resistance for detecting current. The control circuit 16 consists of a microcomputer and an oscillation circuit. The voltage conversion circuit 18 converts output voltage of the AC adapter 17 into a voltage suitable to circuit operation of each section in the power transmission device 10 and supplies it. The power transmission device 10 includes a communication module 40 and the power receiving device 20 includes a communication module 41. The control circuits 16 and 27 exchange information relating to the power transmission and power reception in a non-contact manner through the communication modules 40 and 41.

The power transmission circuit 11 generates AC power of frequency identical or almost identical to self-resonant frequency of the resonance circuit constituted by the condenser 12 and the power transmission coil 13. The power transmission circuit 11 has FET as a switching element and turns on/off the FET through the output of the oscillation circuit in the control circuit 16. The oscillation circuit in the control circuit 16 oscillates at a frequency identical or almost identical to self-resonant frequency of the resonance circuit constituted by the condenser 12 and the power transmission coil 13. In the first embodiment, an operation of supplying or stopping supplying power from the power transmission device 10 to the power receiving device 20 is carried out by the switching circuit 19. Without the use of the switching circuit 19, it is also possible to supply or stop supplying power from the power transmission device 10 to the power receiving device 20 by turning on/off the switching element.

The frequency of the AC power generated by the power transmission circuit 11 uses a frequency of about 100 kHz in a case of using an electromagnetic induction system in power transmission and uses a frequency of a few MHz-tens of MHz in a case of using a magnetic field resonance system in power transmission. In a case of the magnetic field resonance system, specifically, 6.78 MHz and 13.56 MHz are often used. The present embodiment adopts 6.78 MHz. The present embodiment is not limited to operation frequency, and the electromagnetic induction system and the magnetic field resonance system can be used in a wide frequency band.

The power receiving device 20 is provided with a resonance element constituted by a power receiving coil 21 and a condenser 22, a rectifier circuit 23 for converting alternating current into direct current, a voltage conversion circuit 24 for converting DC voltage output by the rectifier circuit 23 into a desired DC voltage and a load circuit 25. Moreover, the power receiving device 20 further includes a switching circuit 26 for connecting/disconnecting the voltage conversion circuit 24 and the load circuit 25. A control circuit 27 controls the connection/disconnection of the switching circuit 26. The power receiving device 20 is also provided with a voltage conversion circuit 28 which converts DC voltage output by the rectifier circuit 23 into a DC voltage required by the control circuit 27. The control circuit 27 is a microcomputer.

Self-resonant frequency of the resonance circuit constituted by the power receiving coil 21 and the condenser 22 of the power receiving device 20 is identical or almost identical to the self-resonant frequency of the resonance circuit constituted by the condenser 12 and the power transmission coil 13 of the power transmission device 10. Due to the identical frequency, the electromagnetism is combined with each other and the power is transmitted from power transmission side to power receiving side more efficiently.

The load circuit 25 is a circuit of electronic equipment such as a portable terminal and a tablet terminal. The power received by the power receiving device 20 is used to operate the electronic equipment and charge the battery such as lithium ion built in the electronic equipment. It is described that the load circuit 25 is built in the power receiving device 20; however, the load circuit 25 may be arranged at the outside of the power receiving device 20 and connected with the switching circuit 26 of the power receiving device 20 through a connector.

The condensers 12 and 22 are not necessarily constituted with electronic components which can also be replaced by electrostatic capacity between lines of each coil according to shapes of the power transmission coil 13 and the power receiving coil 21. Further, the condenser 12 and the power transmission coil 13 are arranged in series and the condenser 22 and the power receiving coil 21 are arranged in series as well to constitute a series resonance circuit. In place of the series resonance circuit, the condenser 12 and the power transmission coil 13 may be arranged in parallel and the condenser 22 and the power receiving coil 21 may be arranged in parallel as well to constitute a parallel resonance circuit.

FIG. 2 shows the non-contact power transmission apparatus 100 in which the power receiving device 20 is arranged on the power transmission device 10. The power receiving device 20 is placed on the power transmission device 10 in a direction indicated by an arrow and the power is transmitted to the power receiving device 20 by overlapping the power receiving coil 21 with the power transmission coil 13 of the power transmission device 10. That is, the AC current flows in the power transmission coil 13 and thus magnetic field occurs in the power transmission coil 13. On the other hand, under the effect of the electromagnetic coupling in the power receiving coil 21, the AC current flows in the power receiving coil 21 and the DC power can be obtained by rectifying the current in the power receiving coil 21.

In FIG. 2, the power transmission device 10 consists of a plate-shaped housing which makes the power receiving device 20 easy to be placed thereon, and the power transmission coil 13 is arranged at the side of the power receiving device 20 inside the housing. The power receiving device 20, which has a plate-shaped housing, can be placed on the power transmission device 10. In the power receiving device 20, the power receiving coil 21 is arranged at the side of the power transmission device 10 inside the housing to face the power transmission coil 13.

The control structures of the power transmission device 10 and the power receiving device 20 of the non-contact power transmission apparatus 100 are described. A foreign object detection operation in a case in which a foreign object such as a metal, IC card and the like is nipped is mainly described.

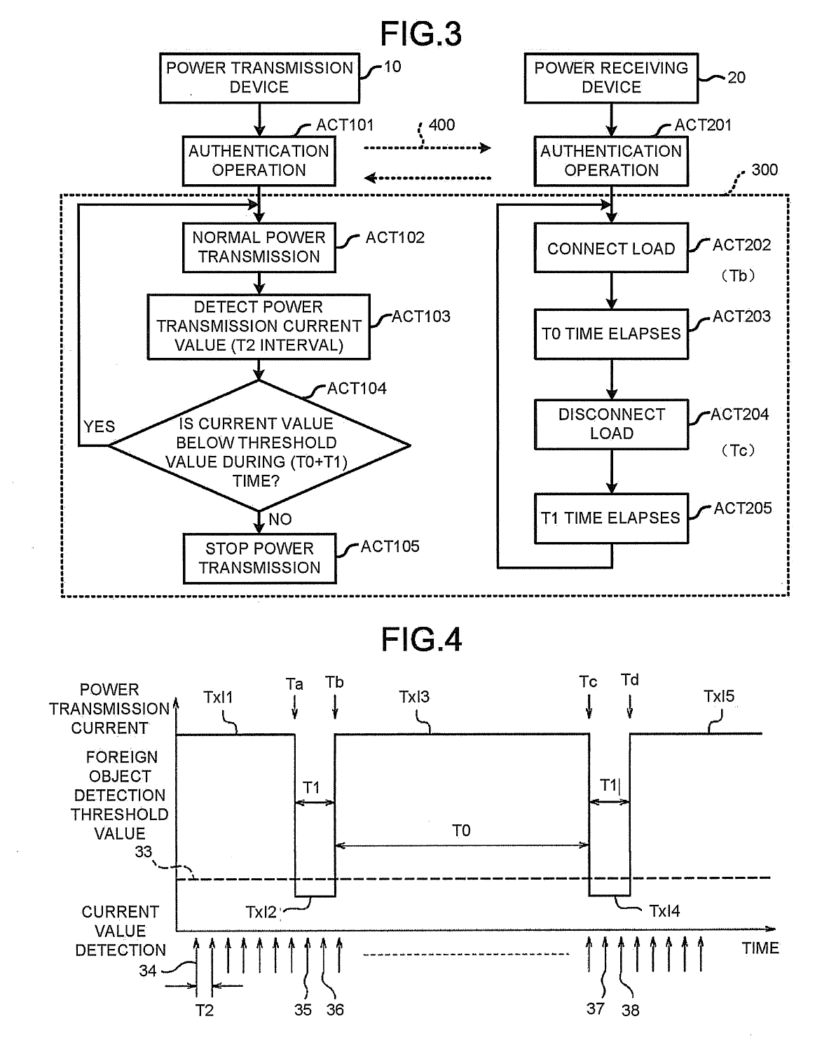

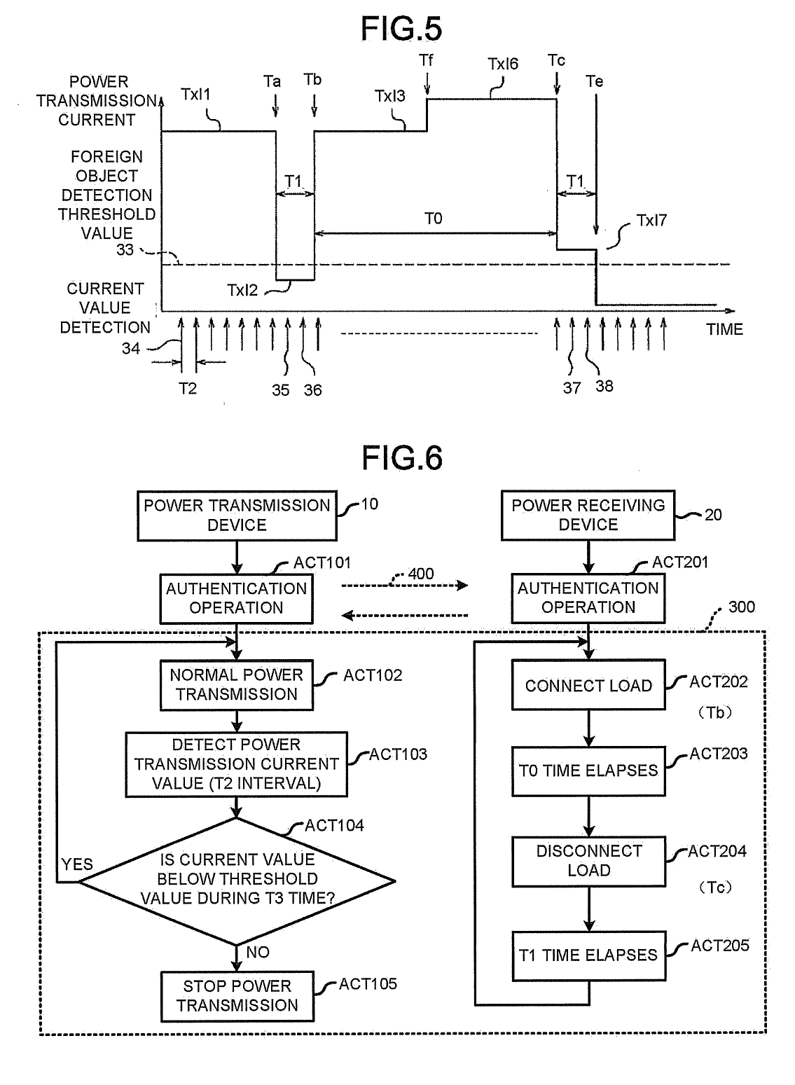

FIG. 3 is a flowchart illustrating the operation during the charging to the battery of the load circuit 25. FIG. 4 shows a timing diagram in a case in which the foreign object does not exist between the power transmission device 10 and the power receiving device 20. FIG. 5 shows a timing diagram in a case in which the foreign object exists between the power transmission device 10 and the power receiving device 20.

If the power receiving device 20 is placed on the power transmission device 10, first, an authentication operation for confirming whether or not the power receiving device 20 is a regular power receiving device 20 is carried out. After the authentication is confirmed, the power is transmitted from the power transmission device 10 to the power receiving device 20, and the processing proceeds to a charging operation (300). The control circuit 16 inquires a unique ID of the power receiving device 20 from the power transmission device 10 to the power receiving device 20 in an authentication operation Act 101. The control circuit 27 responds the unique ID of the power receiving device 20 to the power transmission device 10 in response to the inquiry in the authentication operation ACT 101. Through the inquiry of the ID from the power transmission device 10 to the power receiving device 20 and the response from the power receiving device 20 to the power transmission device 10, whether or not the power receiving device 20 is a regular power receiving device 20 which should be charged is determined by the power transmission device 10. In a case of a regular ID, the charging operation 300 is carried out, and in a case of non-regular ID, the power transmission is stopped and the charging operation is not carried out. The inquiry of ID is carried out through the communication modules 40 and 41 respectively arranged in the power transmission device 10 and the power receiving device 20. The communication modules 40 and 41 may be, for example, a wireless communication module such as wireless communication and infrared ray communication, or may use both the power transmission and the communication module which consists of the power transmission coil 13 and the power receiving coil 21 as a load modulation system. In the present embodiment, no specific limitation is given to the method of the authentication operation.

In the power transmission device 10, after the authentication operation (ACT 101) is completed, the control circuit 16 carries out a normal power transmission to the power transmission circuit (ACT 102). During the normal power transmission, the control circuit 16 detects power transmission current value at a time interval of T2 (ACT 103). The power transmission current value can be obtained by amplifying a small potential difference detected by the current sensor 14 in the power transmission device 10 by the current detection circuit 15 and converting the voltage value into the current value by the control circuit 16.

In a state in which the power receiving device 20 receives the power from the power transmission device 10 in a non-contact manner, the control circuit 27 of the power receiving device 20 switches the switching circuit 26 every a specified time to connect/disconnect the load circuit 25. As shown in FIG. 3, in the power receiving device 20, the load is connected (ACT 202), and then after T0 time elapses (ACT 203), the load is disconnected (ACT 204). Then, the load is connected again (ACT 202) after T1 time elapses (ACT 205), and this operation is repeated. Herein, there is a relationship, that is, T2<T1<T0. During the period T0, the load circuit 25 is charged, and the load circuit 25 is not charged during the period T1. Therefore, power transmission efficiency changes in response to the ratio of non-charging period T1 to charging period T0. In order to charge more efficiently, it is necessary that T1 is a sufficiently small value with respect to T0. In order to detect the foreign object more correctly, it is necessary to select T2 period during which the current can be detected many times during T1 period.

The control circuit 16 of the power transmission device 10 monitors whether or not the power transmission current value is below a foreign object detection threshold value 33 over at least (T0+T1) time (ACT 104), and if the power transmission current value is below the foreign object detection threshold value 33, it is determined that there is no foreign object and power transmission is continued (ACT 102). On the other hand, if the power transmission current value is above the foreign object detection threshold value 33 over (T0+T1) time, it is determined that there is a foreign object and power transmission is stopped (ACT 105).

The timing diagram shown in FIG. 4 indicates the change of the power transmission current during the charging operation (300). If the control circuit 27 of the power receiving device 20 carries out a control processing to disconnect the load circuit 25 at timing of Ta from the moment the power transmission is started, power transmission current TxI1, which flows to supply the power to the load circuit 25 by that time, is lowered to a level of TxI2 due to the load disconnection.

If the load circuit 25 is disconnected, the state is nearly equal to a state in which there is no power receiving device 20, observing from the power transmission device 10, and is a state in which the load is very light. As the load is light, the power transmission current is lowered to such a degree that it is consumed nearly within the power transmission device 10.

Next, at timing of Tb after the T1 time elapses from the timing of Ta, the control circuit 27 of the power receiving device 20 switches the switching circuit 26 to connect the load circuit 25 with the voltage conversion circuit 24. As the load circuit 25 is connected, observing from the power transmission device 10, the load becomes heavy, the power is supplied to the load circuit 25 and thus the power transmission current rises to a level of TxI3. Herein, if the state of the load circuit 25 does not change compared with the timing previous to timing Ta, the level of TxI3 is equal to the level of TxI1.

The control circuit 27 of the power transmission device 20 disconnects the load circuit 25 again at timing Tc after T0 time elapses from the timing Tb during which the load circuit 25 is connected. Due to the load disconnection, the level of the power transmission current is lowered to TxI4. If the load circuit 25 is connected again at timing Td after the T1 time elapses from the timing Tc, the level of the power transmission current rises to TxI5. In particular, if a phenomenon that the foreign object is nipped between the power transmission device 10 and the power receiving device 20 does not occur, the TxI4 is almost equal to the TxI2 and the TxI5 is almost equal to the TxI3. In this way, the control circuit 27 of the power transmission device 20 repeats the operations of disconnecting the load circuit 25, connecting the load circuit 25 after T1 time and disconnecting the load circuit 25 again after T0 time during the charging operation.

The control circuit 16 of the power transmission device 10 sets the foreign object detection threshold value 33 as a threshold value of the current value for detecting the foreign object in advance. In a state in which the load circuit 25 is disconnected, the foreign object detection threshold value 33 is set to be a value greater than the values of current TxI2 and current TxI4 flowing through the power transmission device 10. If the foreign object detection threshold value 33 is far greater than the values of current TxI2 and current TxI4, as foreign object such as IC card the change of the power transmission current in which is relatively small cannot be detected, it is necessary to set the current TxI2 and current TxI4 to a proper value. If the foreign object is not nipped between the power transmission device 10 and the power receiving device 20, as shown in FIG. 4, the current values between the timing Ta and timing Tb and between the timing Tc and timing Td during which the load circuit 25 is disconnected are smaller than the foreign object detection threshold value 33. Thus, the current values detected at timings of current value detections 35 to 36 and 37 to 38 are smaller than the foreign object detection threshold value 33, and as it is determined that there is no foreign object, the power transmission is continued.

It is assumed that T0 is 1 s, T1 is 100 ms and T2 is 10 ms as specific values. The power transmission current value TxI1 is 800 mA in a state of no foreign object (normal state) and the power transmission current value TxI2 is 100 mA in a state of disconnecting the load. It is assumed that the IC card is inserted between the power transmission device 10 and the power receiving device 20 and the current threshold value 33 is 120 mA.

The operation in a case in which the foreign object is nipped between the power transmission device 10 and the power receiving device 20 is described during the charging operation with reference to FIG. 5.

The operation before timing Tf when the foreign object is nipped is similar to the case shown in FIG. 4. At the timing Tf, if the foreign object such as a coin and an IC card is nipped, the power is also supplied to the foreign object to increase the power to be supplied and thus the power transmission current is also increased from TxI3 to TxI6. If the control circuit 27 of the power receiving device 20 carries out a control to detach the load circuit 25 at timing Tc after T0 time elapses from the timing Tb, the power transmission current is reduced from TxI6 to TxI7. The power transmission current is reduced to TxI7; however, as the foreign object remains nipped, the power is supplied to the foreign object from the power transmission device 10. As the power is continuously supplied to nipped foreign object, the value of TxI7 is greater than the current value TxI2 in a state in which no foreign object is nipped. As a result, the value of TxI7 is higher than the foreign object detection threshold value 33.

At timing of current value detection 37 to 38, the control circuit 16 of the power transmission device 10 detects that the power transmission current value TxI7 exceeds the foreign object detection threshold value 33. If the power transmission current value is never below the foreign object detection threshold value 33 during the (T0+T1) time (ACT 104), it is determined that the foreign object exists and the control circuit 16 stops the power transmission at timing Te (ACT 105). Specifically, the control circuit 16 controls the switching circuit 19 and the current is not supplied to the power transmission circuit 11.

The time Ta from the moment the power receiving device 20 starts receiving power to the moment the switching circuit 26 disconnects the load circuit 25 is not determined with the structure of the power receiving device 20. As Ta is not determined, in a case in which the power transmission current value is above the foreign object detection threshold value 33 during the period of at least (T0+T1), the control circuit 16 determines that the foreign object exists. With such a structure, during the period when the load circuit 25 is charged in a non-contact manner, even if the foreign object is nipped between the power transmission device 10 and the power receiving device 20, it is possible to detect the foreign object.

In the forgoing embodiment, the foreign object detection threshold value 33 is set between the current value TxI2 or TxI4 in a state in which the load circuit 25 of the power receiving device 20 is detached and the foreign object is not mixed yet and the current value TxI7 at the time the foreign object is mixed. On the other hand, even if the foreign object detection threshold value 33 is set between the current value TxI3 during charging and the current value TxI6 at the time the foreign object is mixed during charging, the detection of the foreign object is possible. However, the current during charging changes according to the remaining amount of secondary battery serving as the load circuit 25 and the power transmission current changes even according to the position where the power receiving device 20 is placed, thus it is difficult to detect the foreign object stably. Therefore, it is desired to use a small current change in no-load state to set the foreign object detection threshold value 33. By determining the foreign object detection threshold value 33 in advance based on the current in no-load state, even if the foreign object in which the change of the power transmission current is tiny is nipped, the non-contact power transmission apparatus 100 of the present embodiment can detect the foreign object.

### Second Embodiment

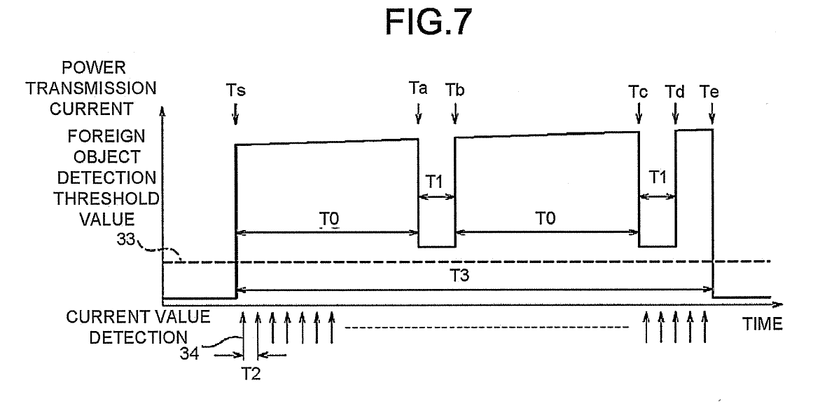

The second embodiment is described with reference to FIG. 6 and FIG. 7. FIG. 6 is a flowchart of the second embodiment. FIG. 7 shows a timing diagram of current detection according to the second embodiment. In the second embodiment, it is described that the foreign object has already existed from Ts time when charging is started. Prior to the Ts time, the execution of authentication operation between the power transmission device 10 and the power receiving device 20 is completed, and it is assumed that the authentication is established. In the second embodiment, the authentication state is assumed but the authentication operation is not particularly necessary, and there may be a system in which charging is started if the power receiving device 20 is placed on the power transmission device 10. The apparatus structure of the second embodiment includes the structures of the power transmission device 10 and the power receiving device 20 described in the first embodiment.

Firstly, the power transmission device 10 carries out authentication operation (ACT 101). ID is responded (400) by authentication operation (ACT 201) of the power receiving device 20 in response to the inquiry of ID from the power transmission device 10. After the authentication is determined, charging operation 300 is carried out. If the power transmission is started at Ts (ACT 102), the power transmission device 10 detects the power transmission current value at a specified time interval of T2 (ACT 103). The control circuit 16 detects whether or not the power transmission current value is below the foreign object detection threshold value 33 during the T3 time (ACT 104). At any timing of every T2 interval during the period of T3, it is determined that there is no foreign object if the power transmission current value is below the foreign object detection threshold value 33 and the power transmission is continued (ACT 102). During the period of T3, it is determined that there is a foreign object if the power transmission current value is never below the foreign object detection threshold value 33 and the power transmission is stopped (ACT 105).

Similar to the first embodiment, the power receiving device 20 repeats a control processing, that is, the load is connected (ACT 202), the load is disconnected (ACT 204) after T0 time elapses (ACT 203) and then the load is connected again (ACT 202) after T1 time elapses (ACT 205). Time intervals T2, T1 and T0 have a relationship, that is, T2<T1<T0, similar to the first embodiment.

The period T3 is determined in consideration of period T0 of charging operation and period T1 of non-charging operation as shown in FIG. 7. The load circuit 25 is charged at period T0 and the load circuit 25 is not charged at period T1. It is necessary that period T3 is at least (T0+T1) time; however it is preferably longer than the (T0+T1) time in order to avoid error operations of foreign object determination. In the second embodiment, T3 is a long time slightly longer than 2*(T0+T1) time. However, if T3 time is too long, too much time is needed to determine whether or not there is a foreign object, and thus it is necessary to determine time T3 required for the foreign object determination taking event probability of the error operations into consideration.

In FIG. 7, if the power receiving device 20 is started to be charged from Ts time, a state in which the power transmission current is slowly increasing is indicated. In a case in which the load circuit 25 of the power receiving device 20 is a lithium ion battery, charging power is increased until the load circuit 25 is close to a full charge state generally. Thus, the power transmission current is slowly increasing during periods from Ts to Ta and from Tb to Tc. The lithium ion battery is widely used in the portable terminal and the like.

On the other hand, during a period (T1) from Ta to Tb and a period (T1) from Tc to Td, the load circuit 25 is in a non-charging state, and thus the power transmission current is a constant value. Therefore, if the foreign object detection threshold value 33 is set to be slightly higher than the power transmission current value of a state in which the load circuit 25 is detached, error detection of the foreign object can also be reduced.

As the power transmission current value is above the foreign object detection threshold value 33 over T3 time, the power transmission device 10 determines that the foreign object exists and stops the power transmission at timing Te (ACT105).

The control circuit 16 of the power transmission device 10 holds charging period T0, non-charging period T1 and time T3 of determining foreign object in advance and conveys T0 time and T1 time from the power transmission device 10 to the power receiving device 20. In place of this method, before the charging operation is started, exchange of information (400) is carried out between the power transmission device 10 and the power receiving device 20 and T3 time is calculated according to information of T0 time and T1 time held by the power receiving device 20 in advance.

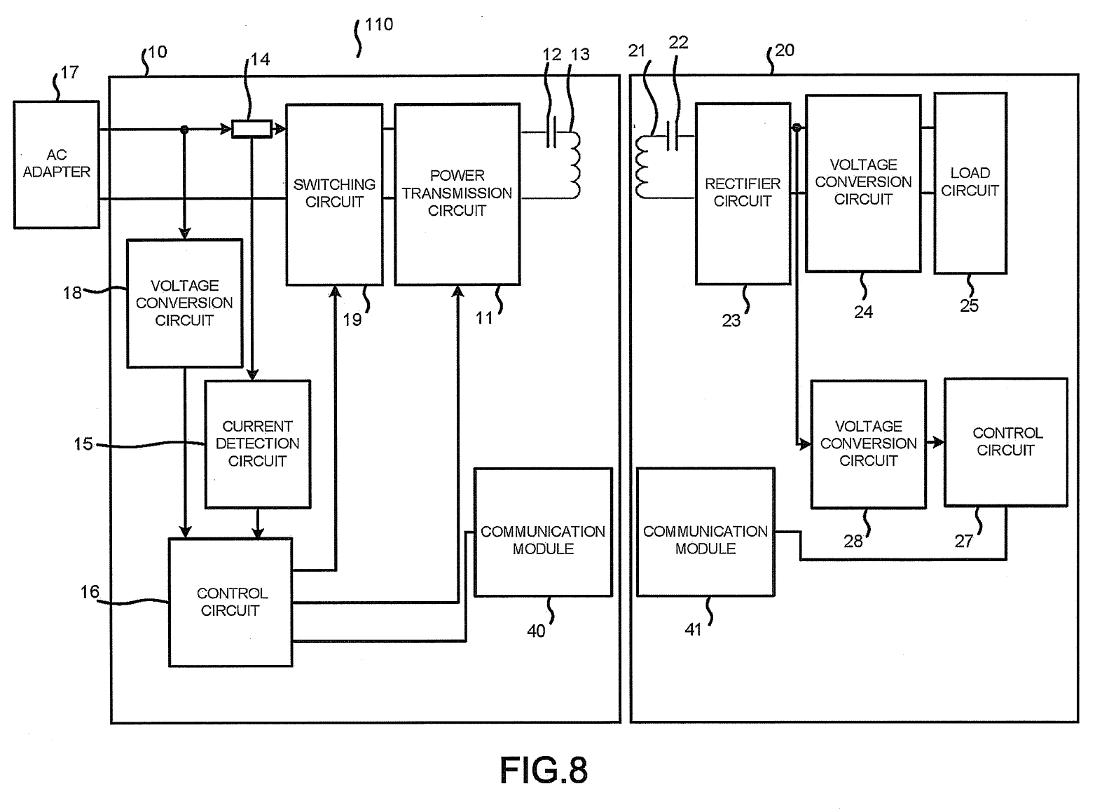

FIG. 8 shows the structure of other non-contact power transmission apparatus 110. The non-contact power transmission apparatus 110 is the same as the non-contact power transmission apparatus 100 of the first embodiment except that the power receiving device 20 uses a voltage conversion circuit 24 with enable/disable function. In a case of using DC/DC converter IC in the voltage conversion circuit 24, the voltage conversion circuit 24 with enable/disable function is used with DC/DC converter IC to replace the functions of the switching circuit 26. That is, voltage generated by the voltage conversion circuit 24 functions as the switching circuit 26 to connect/disconnect with the load circuit 25. Consequentially, the power receiving device 20 can be simply constituted. The structure of using the voltage conversion circuit 24 with enable/disable function is applicable from the first embodiment to the third embodiment.

Even with the structure described in the second embodiment above, during a non-contact charging process, it is possible to easily detect a state where a foreign object in which current change is tiny is inserted between the power transmission device and the power receiving device.

### Third Embodiment

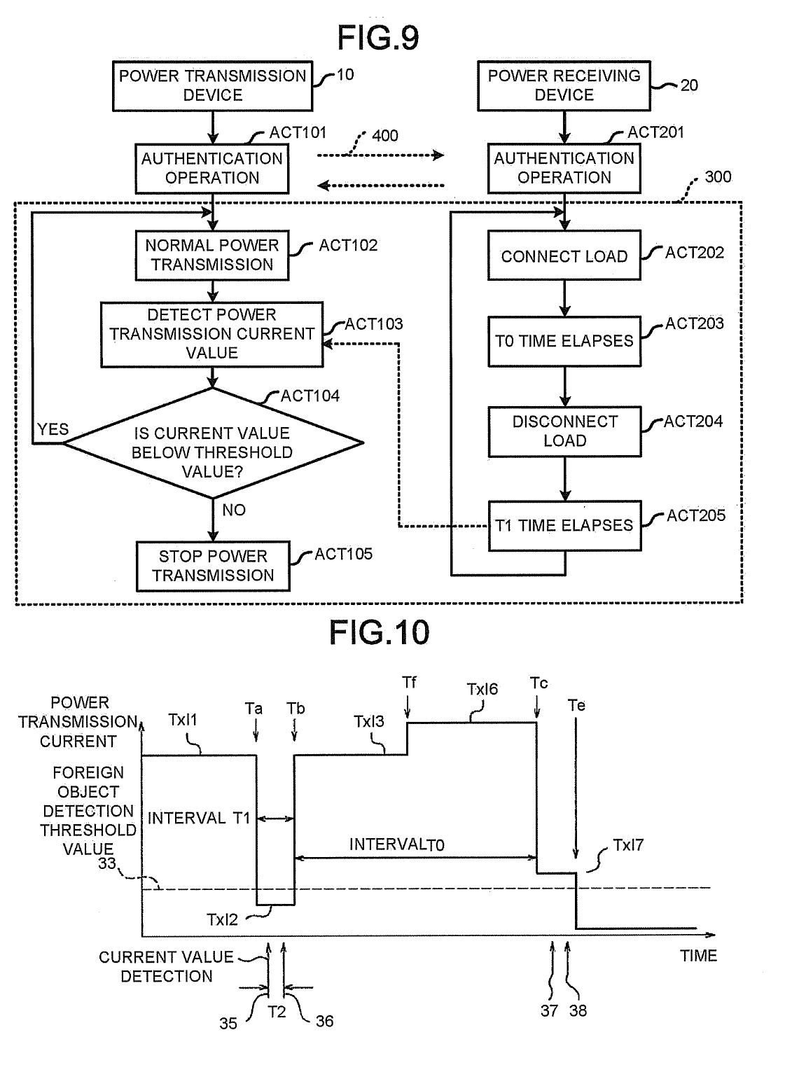

The third embodiment is described with reference to FIG. 9 and FIG. 10. Circuit structure is the structure of the non-contact power transmission apparatus 100 or 110 described in the first or second embodiment. The operations of control circuits 16 and 27 are different from that described in the first or second embodiment.

In the third embodiment, communication is carried out between a communication equipment 40 of the power transmission device 10 and a communication equipment 41 of the power receiving device 20 to obtain synchronism, and the power transmission device 10 detects power transmission current only during a timing when the power receiving device 20 detaches the load circuit 25.

FIG. 9 shows a flowchart illustrating foreign object detection during charging process. The operations of the power receiving device 20 are identical to that described in the first and second embodiments. However, the difference is that the control circuit 16 of the power transmission device 10 detects power transmission current value through communication modules 40 and 41 at a timing when T1 time elapses (ACT 205) after load is disconnected (ACT 204).

In the power transmission device 10, the control circuit 16 detects power transmission current value (ACT 103) according to the elapsing of T1 time (ACT 205). By comparing the foreign object detection threshold value 33 and the power transmission current value (ACT 106), the control circuit 16 determines that there is no foreign object if the current value is below the threshold value 33 and then continues normal power transmission (ACT 102), or determines that there is a foreign object if the current value is above the threshold value 33 and then stops power transmission (ACT 105).

FIG. 10 shows a timing chart of the third embodiment. Current value detection is carried out during a period from Ta to Tb and a period from Tc to Te when the power receiving device 20 detaches the load circuit 25. Power transmission current value TxI2 detected by current value detections 35 and 36 is smaller than the foreign object detection threshold value 33, and thus the existence of the foreign object is determined at this point of time. In a state of non-existence of the foreign object, the power transmission current value is assumed to be TxI3. If the foreign object is mixed at Tf timing, the power transmission current only corresponding to a part where, power is deprived by the foreign object is increased (TxI6). Power transmission current value TxI7 detected by current value detections 37 and 38 is greater than the foreign object detection threshold value 33, and thus the control circuit 16 determines the existence of the foreign object and stops the power transmission.

Even in the third embodiment described above, during a non-contact charging process, it is possible to easily detect a state where a foreign object in which current change is tiny is inserted between the power transmission device 10 and the power receiving device 20.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A non-contact power transmission apparatus, comprising:
a power transmission device which includes a power transmission coil, a power transmission circuit configured to be connected to the power transmission coil and supply power through the power transmission coil, a current detection circuit configured to detect current supplied to the power transmission circuit and a first control circuit configured to control the power transmission circuit; and
a power receiving device which includes a power receiving coil, a rectifier circuit configured to be connected to the power receiving coil, a voltage conversion circuit configured to be connected to the rectifier circuit and convert into voltage of driving a load circuit, a switching circuit configured to connect or disconnect the voltage generated by the voltage conversion circuit with the load circuit and a second control circuit configured to control the switching circuit, wherein
the second control circuit, after starting to receive power, carries out a control processing to connect the load circuit during a period of time T0, then disconnect the load circuit during a period of time T1 and repeat connection and disconnection; and
the first control circuit carries out a control processing to detect repeatedly current values at an interval of time T2 through the current detection circuit and stop power transmission if the current value is above a current threshold value during at least (T0+T1) time.

2. A non-contact power transmission apparatus, comprising:
a power receiving device configured to receive power in a non-contact manner and repeat connection and disconnection with load circuit to supply power to the load circuit; and
a power transmission device configured to detect power transmission current value when power is transmitted to the power transmission device and stop power transmission in a case in which the power transmission current value is greater than current threshold value during a period when the load circuit is detached.

3. A non-contact power transmission apparatus, comprising:
a power transmission device which includes a power transmission coil, a power transmission circuit configured to be connected to the power transmission coil and supply power through the power transmission coil, a current detection circuit configured to detect current supplied to the power transmission circuit and a first control circuit configured to control the power transmission circuit; and
a power receiving device which includes a power receiving coil, a rectifier circuit configured to be connected to the power receiving coil, a voltage conversion circuit configured to be connected to the rectifier circuit and convert into voltage of driving a load circuit, a switching circuit configured to connect or disconnect the voltage conversion circuit with the load circuit and a second control circuit configured to control the switching circuit, wherein
the second control circuit, after starting to receive power, carries out a control processing to connect the load circuit during a period of time T0, then disconnect the load circuit during a period of time T1 and repeat connection and disconnection; and
the first control circuit carries out a control processing to detect current value during a period of the T1 through the current detection circuit and stop power transmission if the current value is above a current threshold value.

4. The non-contact power transmission apparatus according to claim 1, wherein
enable function of the voltage conversion circuit connects or disconnects the load circuit in the power receiving device as the switching circuit.

5. The non-contact power transmission apparatus according to claim 3, wherein
enable function of the voltage conversion circuit connects or disconnects the load circuit in the power receiving device as the switching circuit.

6. A power transmission device, comprising:
a power transmission coil;
a power transmission circuit configured to supply current to the power transmission coil;
a current detection circuit configured to detect current supplied to the power transmission circuit; and
a control circuit configured to carry out a control processing to detect power transmission current value during power transmission through the current detection circuit at a specified time interval and stop power transmission if the power transmission current value is above a current threshold value of a specified time.
